(19) United States
(12) Patent Application Publication
(10) Pub. No.: US 2011/0242050 A1
(43) Pub. Date: Oct. 6, 2011

(54) METHOD AND APPARATUS COMPENSATING PARASITIC CAPACITANCE IN TOUCH PANEL

(75) Inventors: San-ho BYUN, Bucheon-si (KR); Yoon-kyung CHOI, Yongin-si (KR); Jong-hak BAEK, Seoul (KR)

(73) Assignee: SAMSUNG ELECTRONICS CO., LTD., Suwon-si (KR)

(21) Appl. No.: 13/076,686

(22) Filed: Mar. 31, 2011

(30) Foreign Application Priority Data
Apr. 6, 2010 (KR) 10-2010-0031561

(51) Int. Cl. G06F 3/045

(52) U.S. Cl. 345/174

(57) ABSTRACT

A touch controller and touch display device incorporating same are described. The touch controller includes a parasitic capacitance compensation unit that receives a common electrode voltage to generate a quantity of charge capable of compensating for a quantity of charge associated with a parasitic capacitance between a sensing channel and a common electrode in a touch panel capable of capacitive sensing of a touch input.

### CROSS-REFERENCE TO RELATED APPLICATIONS

This application claims the benefit of Korean Patent Application No. 10-2010-0031561 filed on Apr. 6, 2010, the subject matter of which is hereby incorporated by reference.

### BACKGROUND OF THE INVENTION

The inventive concept relates to display systems incorporating a touch panel, and more particularly, to methods of compensating for and/or removing various parasitic capacitances associated with a touch panel so as to maximize sensing sensitivity.

Portable electronic devices have become smaller and thinner to meet user demand. Touch screens that do not include mechanical buttons and switches, and that provide improved performance and appealing designs are widely used, for example, in general asynchronous transfer mode (ATM) devices, televisions (TVs), and general home appliances as well as small-sized devices. In particular, cell phones, portable multimedia players (PMPs), personal digital assistants (PDAs), e-books, and the like, have been greatly reduced in overall size for easy carrying. In order to further reduce the size of portable devices, methods of unifying (or incorporating) user input buttons with a screen has been the subject of intense research and development. Within certain methods of unifying input buttons with a screen, touch perception technology for a touch screen capable of detecting a touch input to a touch panel has become increasingly important.

Generally, a touch screen is an input device operates as an interface between an information communication device having various displays and a user. The user directly contacts the touch screen using an input tool, such as a finger, a pen, or the like. Examples of flat panel display devices including a touch screen include liquid crystal display (LCD) devices, field emission display (FED) devices, organic light-emitting diode (OLED) devices, plasma display (PDP) devices, and the like.

The flat panel display devices generally include a plurality of pixels arranged in a matrix so as to display images. For example, LCD devices may include a plurality of scan lines transmitting gate signals and a plurality of data lines transmitting gray scale data. The plurality of pixels are formed at a point in which the plurality of scan lines and the plurality of data lines intersect. Each of the pixels may include a transistor and a capacitor, or only a capacitor.

A touch screen may use one of several different methods of operation, such as a resistive overlay method, a capacitive overlay method, a surface acoustic wave method, an infrared ray method, a surface elastic wave method, an inductive method, and the like.

In the touch screen using the resistive overlay method, a resistive material is coated on a glass or transparent plastic plate, and a polyester film is covered thereon, and insulating rods are installed at regular intervals so that two sides of the polyester film do not contact each other. In this case, resistance and voltage are varied. The position (e.g., a touch point) of a touch input device (e.g., a user's finger) contacting the touch screen is perceived in relation to a degree of voltage variation. The touch screen using the resistive overlay method has superior characteristics, such as the input of cursive script, but has drawbacks such as low transmittance, low durability, and non-detection of multi-contact points.

In the touch screen using the surface acoustic wave method, a transmitter emitting sound waves and a reflector reflecting the sound waves are attached to a glass surface at regular opposing intervals. When a touch input device interrupts a transmission path for sound waves between the transmitter and reflector, a time value is calculated to detect a corresponding touch point.

In the touch screen using the infrared ray method, directivity of infrared rays are used in a manner similar to the sound waves of a surface acoustic wave method. A matrix is formed by disposing in an opposing manner an infrared light-emitting diode (LED) as a spontaneous emission device and a phototransistor. The interruption of light transmitted between the LED and phototransistor by a touch input device is detected within the matrix, thereby allowing the detection of a corresponding touch point.

Contemporary portable electronic devices mainly use the resistive overlay method which is low cost and capable of operating in response to a range of touch devices. However, as research into user interfaces using a multi-touch have been actively pursued, touch screens using the capacitive overlay method by which multi-touch perception may be performed, has come into the spotlight.

### SUMMARY OF THE INVENTION

Embodiments of the inventive concept provide a touch controller that compensates for and/or removes the effects of certain parasitic capacitances associated with a touch sensing unit. Embodiments of the inventive concept also provide a touch system including this type of touch controller, as well as methods of compensating for parasitic capacitances in touch systems.

In one aspect, the inventive concept provides a touch controller comprising a parasitic capacitance compensation unit. The parasitic capacitance compensation unit receives a common electrode voltage to generate a quantity of charge capable of compensating for a quantity of charge associated with a parasitic capacitance between a sensing channel and a common electrode in a touch panel capable of capacitive sensing of a touch input.

In another aspect, the inventive concept provides a touch display device compensating for parasitic capacitance, the touch display device comprising; a touch panel comprising a plurality of sensing channels that perform a touch screen operation sensing variation in a sensing unit disposed in the plurality of sensing channels, and outputting a variation signal of the sensing unit, and a touch controller comprising a signal conversion unit that receives the variation signal, converts the variation signal into a voltage, and outputs the voltage, wherein the touch controller comprises a parasitic capacitance compensation unit that receives a common electrode voltage to generate a quantity of charge capable of compensating for a quantity of charge associated with a parasitic capacitance between a sensing channel and a common electrode in the touch panel.

In another aspect, the inventive concept comprises a method compensating for parasitic capacitance in a touch system, the method comprising; sensing variation in capacitance for a plurality of sensing units disposed in a plurality of sensing channels in response to a touch input, and outputting a sensing signal corresponding to the variation, receiving, amplifying, and outputting the sensing signal, wherein the receiving, amplifying, and outputting of the sensing signal is performed by a touch controller, and receiving a common electrode voltage to generate a quantity of charge capable of compensating for a quantity of charge associated with a parasitic capacitance between the plurality of sensing channels and a common electrode, wherein the receiving of the common electrode voltage is performed by a parasitic capacitance compensation unit of the touch controller.

### BRIEF DESCRIPTION OF THE DRAWINGS

Embodiments of the inventive concept will be more clearly understood from the following detailed description taken in conjunction with the accompanying drawings in which:

FIG. 1 illustrates a touch screen panel and a signal processing unit for processing touch signals of a touch screen system;

FIG. 2 illustrates a case where a touch is sensed when a touch panel using a mutual capacitive method is used;

FIG. 3 illustrates electromagnetic noise that may occur when operations are performed on a touch screen panel;

FIGS. 4A and 4B are graphs showing the quantity of variation of capacitance due to a touch when noise is present in a display panel;

FIG. 5 illustrates an effect caused by noise in a touch system;

FIG. 6 is an equivalent circuit diagram in which a charge amplifier is simplified;

FIG. 7A is a circuit diagram of a touch controller comprising a parasitic capacitance compensator and a charge amplifier in a touch display device, according to an embodiment of the inventive concept;

FIG. 7B is a circuit diagram of a touch controller comprising a parasitic capacitance compensator and a charge amplifier in a touch display device, according to another embodiment of the inventive concept;

FIG. 7C is a circuit diagram for specifically explaining a method of compensating for a parasitic capacitor using the touch controller of FIG. 7A, according to an embodiment of the inventive concept;

FIG. 7D is a circuit diagram for implementing the method of FIG. 7C, according to an embodiment of the inventive concept;

FIG. 8 is a block diagram of an integrated circuit (IC) in which a touch controller and a display driver circuit are integrated in one chip, according to an embodiment of the inventive concept;

FIGS. 9A through 9D illustrate a structure of a printed circuit board (PCB) of a display device on which a touch panel is disposed, according to an embodiment of the inventive concept;

FIGS. 10A through 10D illustrate a structure of a PCB when a touch panel and a display panel are unified with each other as one body;

FIGS. 11A and 11B illustrate a structure of a semiconductor chip in which a touch controller unit and a display driver circuit unit are integrated, and a structure of a flexible PCB (FPCB);

FIG. 12 illustrates a display device including a semiconductor chip in which a touch controller and a display driver circuit are integrated, according to an embodiment of the inventive concept; and

FIG. 13 illustrates examples for applying various products on which a touch system is mounted, according to an embodiment of the inventive concept.

### DETAILED DESCRIPTION

Reference will now be made in some additional detail to certain embodiments of the inventive concept illustrated in the accompanying drawings. However, the inventive concept may be variously embodied and is not limited to only the illustrated embodiments. Throughout the drawings and written description, like reference numbers and labels are used to denote like or similar elements. In certain drawings, the thickness and relative thicknesses of layers and regions may be exaggerated for clarity.

It will be understood that when an element, such as a layer, a region, or a substrate, is referred to as being “on,” “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of exemplary embodiments.

Spatially relative terms, such as “above,” “upper,” “beneath,” “below,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “above” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but may be to include deviations in shapes that result, for example, from manufacturing.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

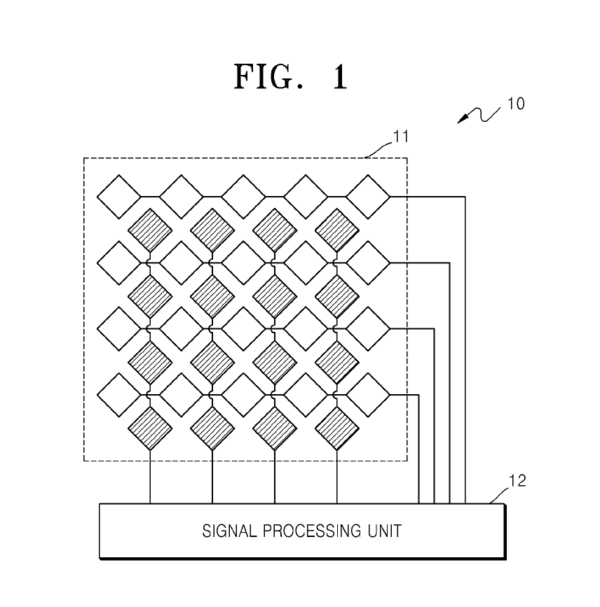

(FIG.) 1 illustrates a touch screen panel and a signal processing unit for processing touch signals of a touch screen system 10. Referring to FIG. 1, the touch screen system 10 comprises a touch screen including a plurality of sensing units, and a signal processing unit 12 capable of sensing a variation in capacitance of the plurality of sensing units of the touch screen panel 11, and processing this variation to effectively detect a touch input and generate corresponding touch data.

The touch screen panel 11 includes a plurality of sensing units disposed in a row direction and a plurality of sensing units disposed in a column direction. As illustrated in FIG. 1, the touch screen panel 11 comprises a plurality of rows in which the plurality of sensing units are disposed. The sensing units disposed in each of the rows are electrically connected to one another. Also, the touch screen panel 11 includes a plurality of columns in which the sensing units are disposed. The sensing units disposed in each of the columns are electrically connected to one another.

The signal processing unit 12 generates touch data by sensing variations in capacitance of the sensing units of the touch screen panel 11. For example, the touch screen system 10 may sense a variation in capacitance between rows and/or columns, thereby detecting a touch input position.

However, there are certain parasitic capacitances that are always present in the sensing units of the touch screen panel 11. The parasitic capacitances may include horizontal capacitance components generated between sensing units, and vertical capacitance components generated between a sensing unit and a display panel. When the cumulative parasitic capacitances are large, the ability of the touch system to faithfully detect a touch input is greatly reduced, since the actual capacitance variation associated with the touch input may be quite small. For example, as a touch input device approaches a predetermined sensing unit, the capacitance of the sensing unit will increase. If the sensing unit has a high parasitic capacitance, corresponding sensing sensitivity will decrease. Also, a variation in an electrode voltage (VCOM) supplied to the top glass of the display panel causes sensing noise during a touch detection operation due to a vertical parasitic capacitance.

Thus, in a touch screen system using a capacitive overlay method, the relative “sizes” (i.e., the associated capacitive variations) for the touch input and the cumulative parasitic capacitance is quite important, and may become a significant system operating characteristic.

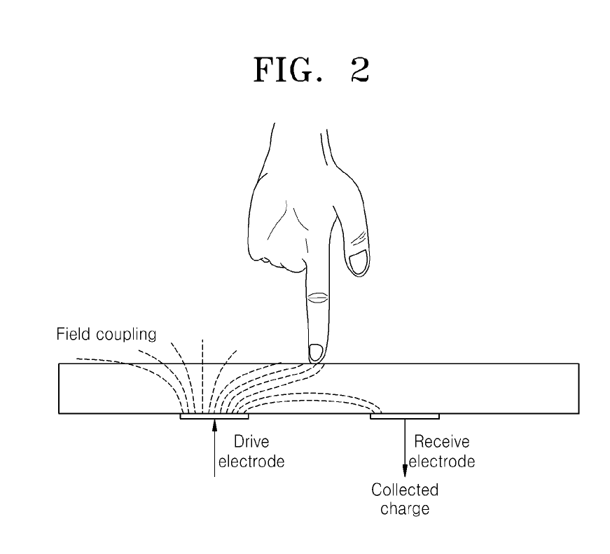

FIG. 2 illustrates a case wherein a touch input is sensed by a touch panel using a mutual capacitive method. Referring to FIG. 2, in the mutual capacitive method, a predetermined voltage pulse is applied to a drive electrode, and electrical charge corresponding to the voltage pulse is collected at a receive electrode. In this regard, when a touch input device (e.g., a user's finger) is placed between the drive electrode and the receive electrode, preexisting electric fields (dotted lines) are varied or interrupted. A system using the touch panel senses a touch input when the capacitance between the two electrodes varies due to variations in the corresponding electric fields.

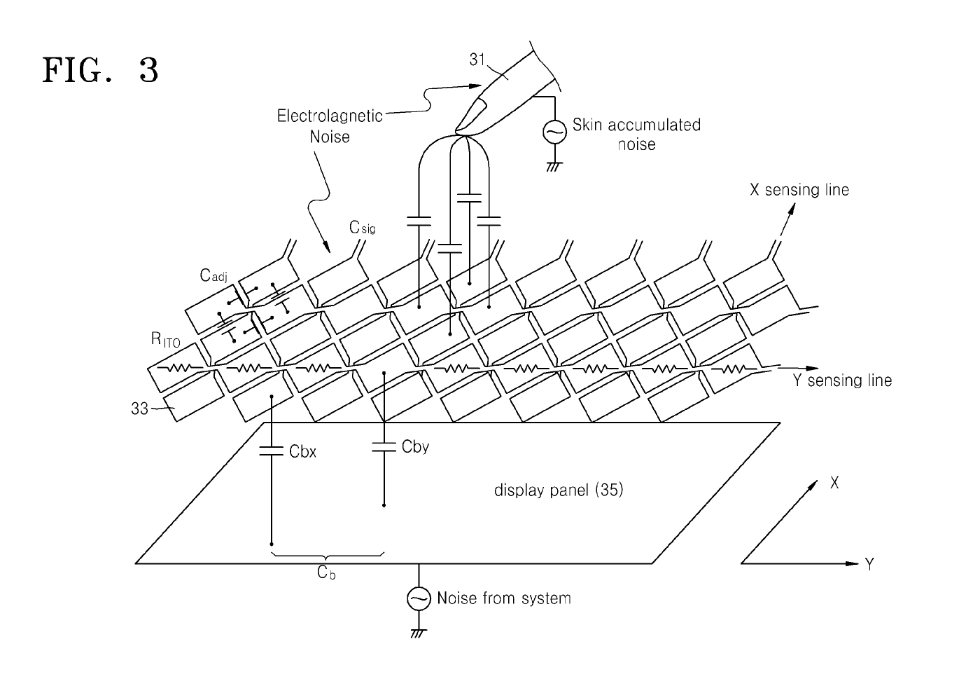

FIG. 3 illustrates electromagnetic noise that may occur when operations are performed on a touch screen panel. A mobile product capable of receiving user input data according to a general touch function tries to reduce the number of processes and to improve price competitiveness by disposing a touch screen panel 33 on a display panel 35, like in an ON-cell type touch panel. If the touch screen panel 33 and the display panel 35 are unified within a common body, another problem occurs. Namely, parasitic capacitances Cbx and Cby, which are generated between a sense channel of the touch screen panel 33 and a data line of the display panel 35, as well as skin accumulated noise or noise from a system, greatly increase. As such, fluctuation in certain voltages associated with several source channels applied to the display panel 35 from a display driver IC (DDI) to drive a display causes noise. Unlike general touch sensing systems, the methods used in the mobile product require development of a new touch sensor circuit must be capable of reducing noise caused by this type of circuitry.

Referring to FIG. 3, the touch screen panel 33 comprises a plurality of sensing units that constitute an x-axis and a y-axis. The plurality of sensing units constitute X sensing lines in the x-axis direction and Y sensing lines in the y-axis direction. An electrical resistance R_{ITO} is present between the X sensing lines and the Y sensing lines. The plurality of sensing units may be disposed adjacent to the display panel 35 for displaying a touched image or may be attached to one surface of the display panel 35. The display panel 35 represents the top glass of the display panel 35 to which the electrode voltage VCOM is supplied. For example, when the top glass of the display panel 35 is an upper panel of a liquid crystal display (LCD) panel, the electrode voltage VCOM may be supplied as a common electrode voltage, and when the top glass of the display panel 35 is an upper panel of an organic light-emitting diode (OLED) panel, the electrode voltage VCOM may be supplied as a cathode voltage having a direct current (DC) voltage.

The touch screen panel 33 may also comprise a plurality of sensing units SU connected to a plurality of sensing lines disposed in a row direction (x-direction) and a plurality of sensing units SU connected to a plurality of sensing lines disposed in a column direction.

The sensing units SU respectively introduce certain parasitic capacitance components associated with their arrangement structure. For example, the sensing units SU introduce a horizontal parasitic capacitance component C_{adj} generated between the adjacent sensing units SU, and vertical parasitic capacitance components Cbx and Cby generated between the sensing units SU and the display panel 35. When the parasitic capacitances are relatively large, as compared with the capacitance components associated with a touch input close to (or contacting) the sensing units SU, even when capacitances of the sensing units SU vary due to the touch input, sensing sensitivity may be significantly decreased.

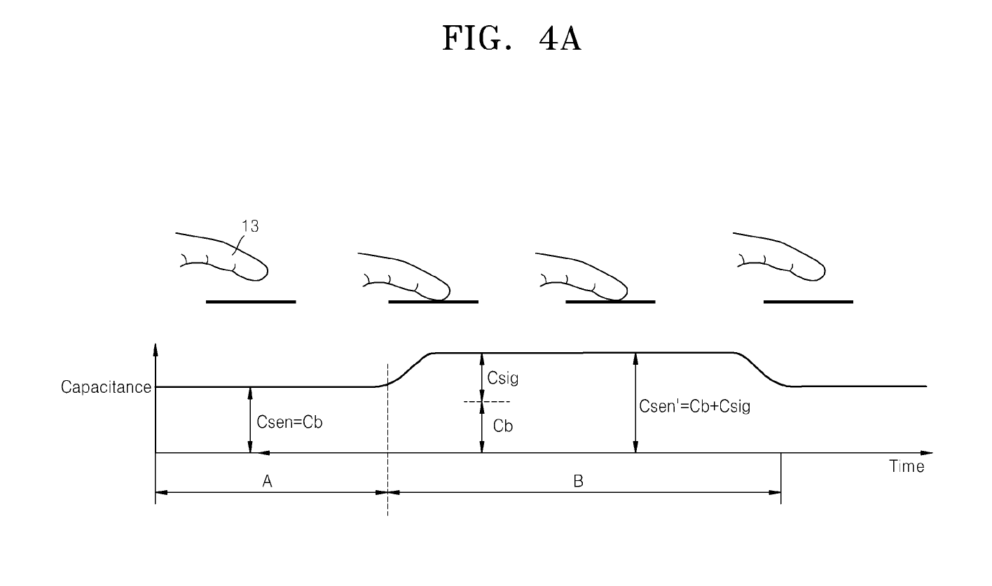

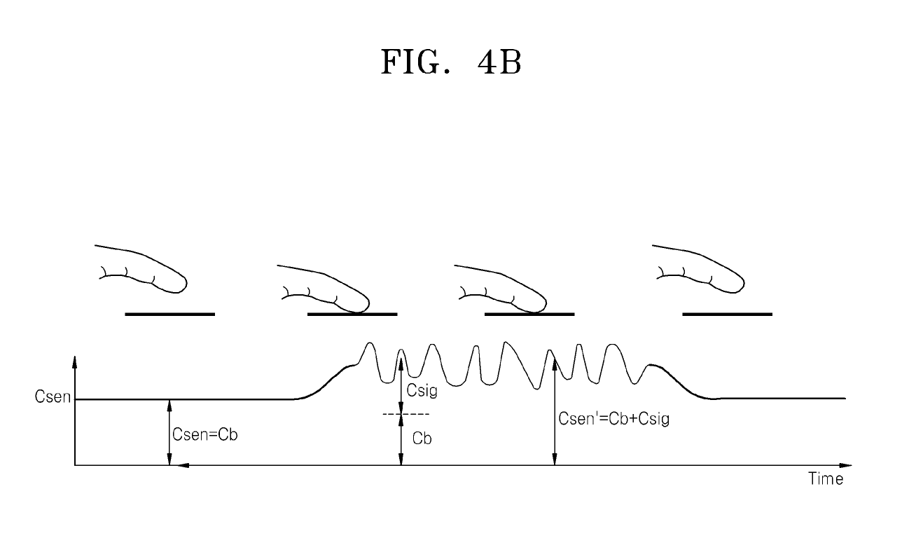

FIGS. 4A and 4B are graphs showing the quantity of variation of capacitance due to a touch input when noise is present in the display panel 35. Referring to FIG. 4A, each of the sensing units SU basically has a parasitic capacitance component C_{b}. A capacitance of the sensing unit SU is varied when a touch input device is close to an object or contacts the object, and thus, an additional capacitance component C_{sig} is generated. For example, when a conductive object is close to the sensing unit SU or contacts the sensing unit SU, the capacitance of the sensing unit SU is increased.

Period A shown in FIG. 4A represents a state where the conductive object does not contact the sensing unit SU. The capacitance Csen of the sensing unit SU may be C_{b}, which corresponds to the parasitic capacitance component. Period B of FIG. 4A represents a state where the conductive object contacts the sensing unit SU. In this case, a capacitance component Csig is additionally generated between the touch input device and the touch screen panel 33, and the capacitance Csen of the sensing unit SU is increased to capacitance Csen′ that is obtained by adding the parasitic capacitance C_{b} and the capacitance component Csig.

However, when various noise is present, as illustrated in FIG. 4B, noise components may greatly affect the capacitance of the sensing unit SU. A touch cannot be accurately sensed due to the capacitance Csen′ of the sensing unit SU having severe fluctuation. As a result, sensing sensitivity of a touch screen device is greatly reduced.

Various types of noise may be generated in the LCD panel and the OLED panel. For example, when a touch panel is disposed on the OLED panel, a common electrode layer for generating a common voltage Vcom is formed under a touch sense channel. The common electrode layer is maintained at a predetermined constant voltage by using an external switching mode power supply (SMPS). Thus, in the case of the OLED panel, noise accumulated in the touch sense channel is very small.

On the other hand, the LCD panel is driven using two methods, i.e., a method of driving a common electrode with a constant voltage and a method of continuously inversing the common electrode. A voltage width of the common electrode is approximately 5V, and thus it is impossible to disregard accumulation of such voltage switching in a touch sense channel. In both the method of driving a common electrode with a constant voltage and the method of continuously inversing the common electrode, much noise is accumulated whenever data is written in a source channel. This is because a LCD panel is affected by slew as well as by the data written to the source channel.

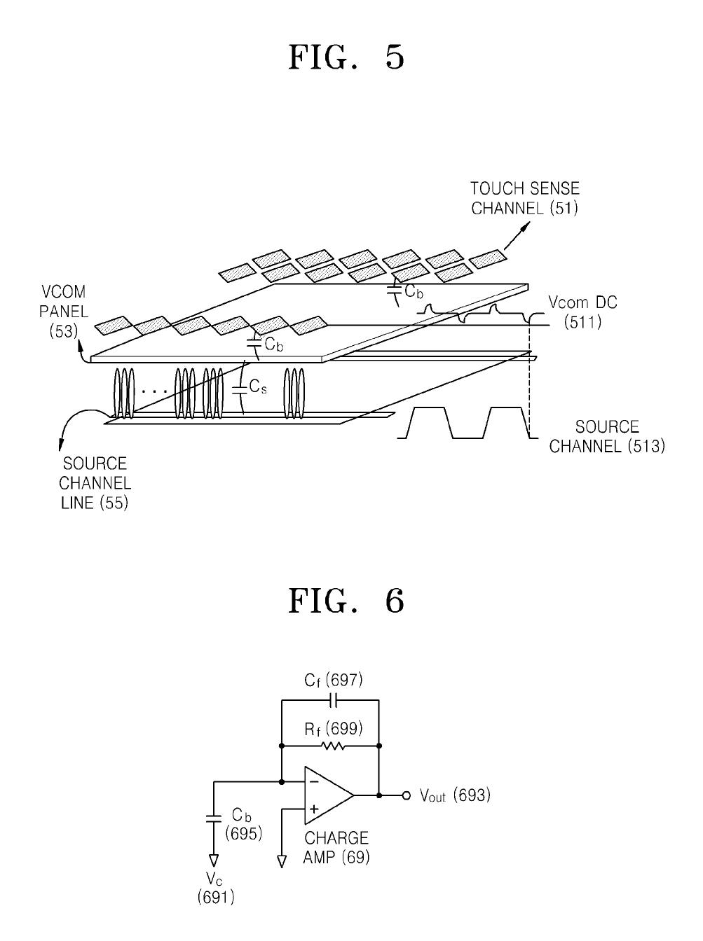

FIG. 5 illustrates an effect caused by noise in a touch system. Referring to FIG. 5, a common electrode voltage Vcom DC 511 is driven as a constant voltage DC by using an active level shifter (ALS) method that is one of the methods of driving the LCD panel, and a boost voltage is applied to a storage capacitor (not shown) disposed on a module. Corresponding source channels 513 are present in an LCD qVGA grade panel. Noise is generated in the Vcom DC 511 due to variation of the source channels 513 disposed on a source channel line 55. A parasitic capacitance Cₛ generated between the source channel 513 and a common electrode (VCOM) panel 53 is 10 nF or more. Also, in the case of an ON-cell type touch panel, a parasitic capacitance C_{b} generated between the touch sense channel 51 and the VCOM panel 53 is several pF or more and is very large. In detail, when the plurality of source channels 513 are simultaneously activated and each data is applied to each touch sense channel 51, noise accumulated in the touch sense channel 51 is greatly increased. On the other hand, as the parasitic capacitance C_{b} decreases, noise accumulated in the touch sense channel 51 is greatly decreased. Also, as voltage swing widths of the source channels 513 increase, noise components accumulated in the VCOM panel 53 increase. A circuit for driving the common electrode VCOM is a DDI internal block, and there is a limitation in increasing the bandwidth of the DDI internal block. Thus, noise accumulated in the source channels 513 cannot be stabilized within a short time. Such noise may cause an abnormal value or fluctuation in a coordinate value that is a final result of a touch sensor. Thus, the effect of the parasitic capacitance C_{b} of several tens pF that occurs between the touch sense channel 51 and the VCOM panel 53 must be minimized.

Further, it is essential to place a so-called “protection layer” under a touch sense channel of a general LCD touch panel in order to remove display noise. A main source of display noise is noise generated when data is written to a common electrode modulation voltage and a source channel as described above. However, the provision of a protection layer mandates the performance of related manufacturing processes and drives up the cost of fabrication. It also adversely increases the thickness of the panel.

FIG. 6 is an equivalent circuit diagram in which a charge amp 69 is simplified.

Peripheral circuits and an effect caused by a parasitic resistance and capacitor components are not shown in FIG. 6. A noise source accumulated in the VCOM panel 53 when one is selected from a plurality of touch sense channels is defined as V_{c} 691. A transfer function from the noise source V_{c} 691 to the output terminal of the charge amp 69 is simplified using Equation 1:

$${V}_{out} = - \frac{{sC}_{b} {R}_{f}}{1 + {sC}_{f} {R}_{f}} {V}_{c} \qquad ( 1 )$$

In Equation 1, the value of a resistor R_{f} 699 is several mega ohms (MΩ) and is very large. As a result, the ratio of an output voltage Vₒᵤₜ 694 to the noise source V_{c} 691 is shown as the ratio of capacitances of a capacitor C_{b} 695 and a capacitor C_{f} 697, as shown in Equation 2:

$$\frac{{V}_{out}}{{V}_{c}} = - \frac{{C}_{b}}{{C}_{f}} \qquad ( 2 )$$

Generally, in the case of the ON-cell type touch panel, the capacitance of the capacitor C_{b} 695 is several tens pF or more and thus, a gain caused by noise is 1 or more. In detail, the charge amp 69, which is a differential amplifier, increases noise accumulated in the VCOM panel 53 according to a gain caused by the capacitor C_{b} 695 and the capacitor C_{f} 697. This makes the output of the charge amp 69 be out of a dynamic region, and thus touch sensing cannot be substantially performed. In order to perform touch sensing without this problem, a method of reducing display noise is needed.

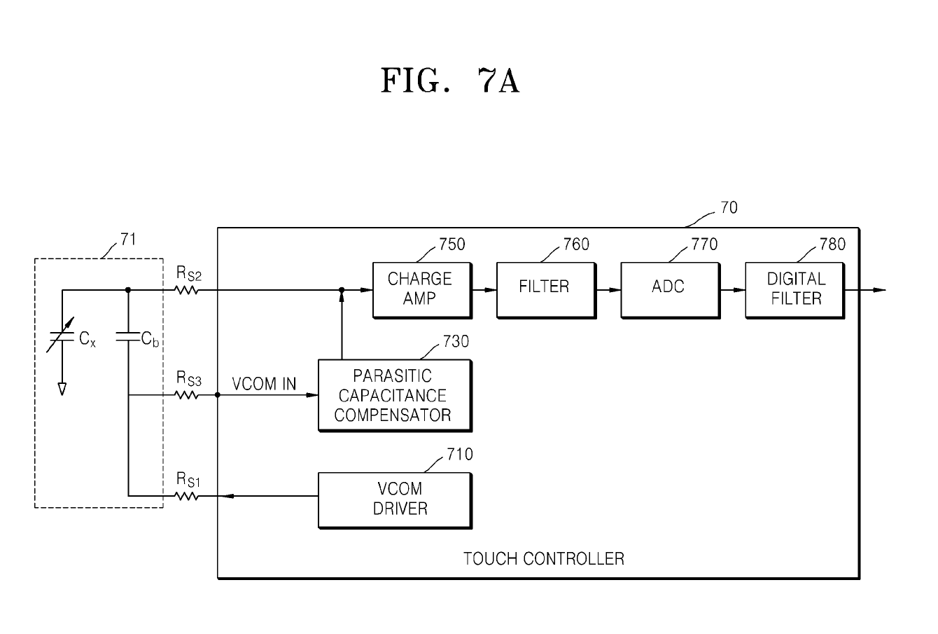

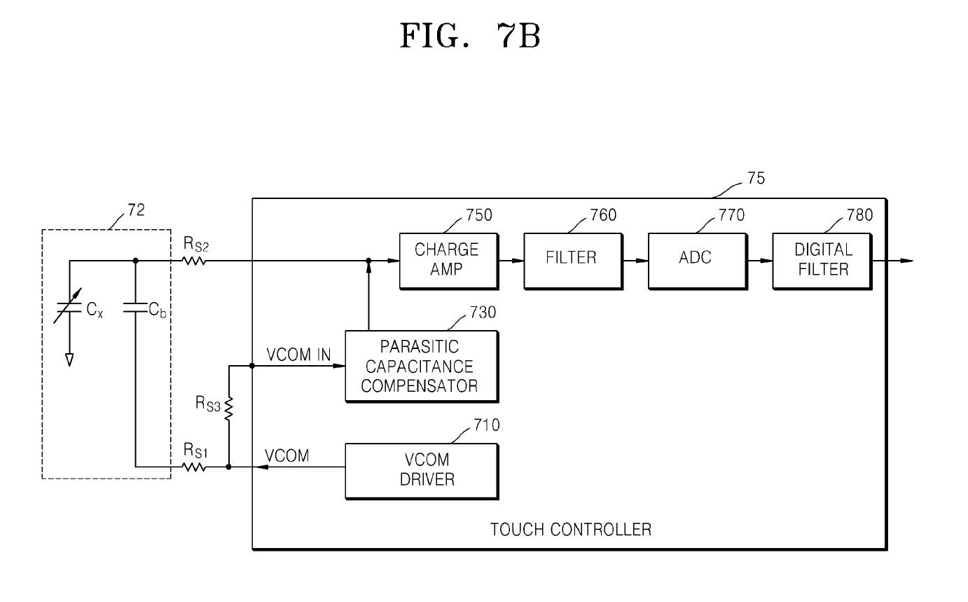

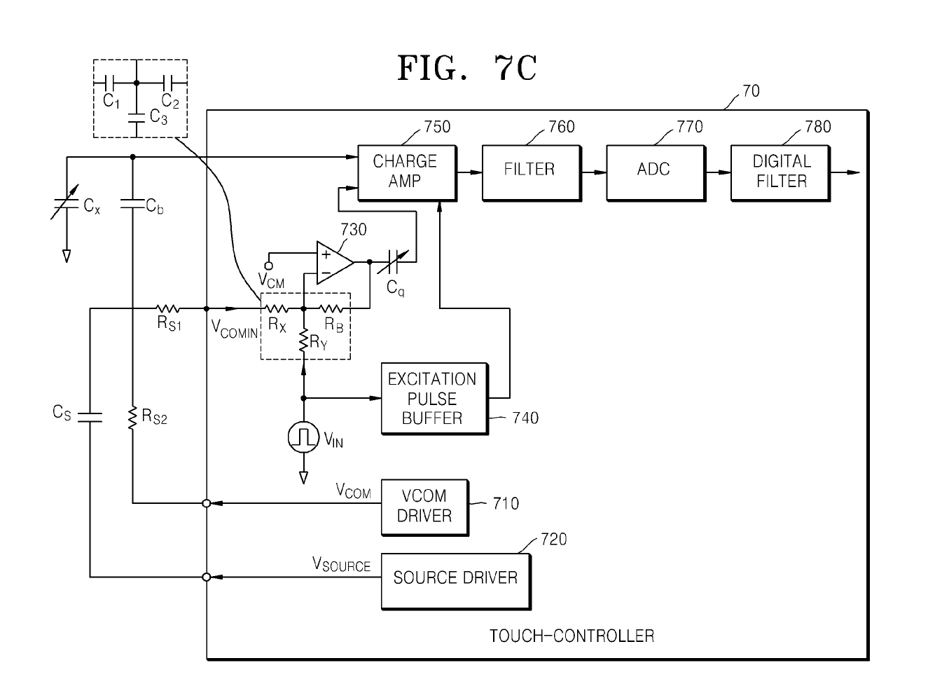

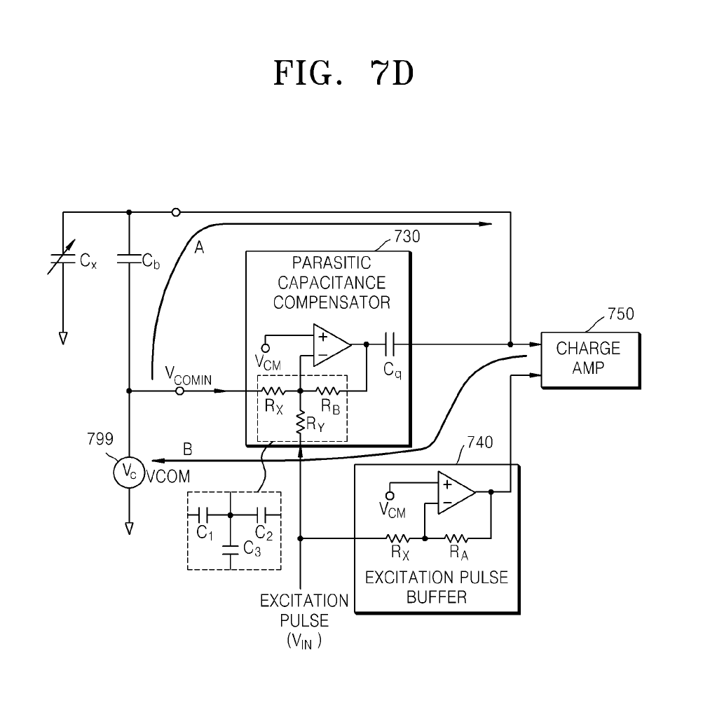

FIG. 7A is a circuit diagram of a touch controller 70 comprising a parasitic capacitance compensator 730 and a charge amplifier 750 in a touch display device, according to an embodiment of the inventive concept.

The term “touch controller” is generally used in relation to certain embodiments of the inventive concept to denote a circuit portion of a touch-DDI or a replacement thereof. The charge amplifier 750 is a signal conversion unit that converts an input touch signal into a voltage signal and amplifies the voltage signal, if necessary, and includes a differential op amplifier.

Referring to FIG. 7A, the capacitance Cx may be understood as a value modeling the capacitance associated with a touch input, the capacitance Cb may be similarly understood as a value associated with certain a parasitic capacitance(s) that arise between a touch sense channel and a common electrode. Resistance values Rₛ₁, Rₛ₂, and Rₛ₃ denote certain parasitic resistances resistors generated when the touch controller 70 is connected to a touch panel 71. When a common electrode protection layer is removed, a common electrode modulation voltage VCOMIN is applied to an electrode under the parasitic capacitor Cb, which affects the touch sense channel.

The touch display device of the illustrated embodiment compensates for the parasitic capacitance Cb using the common electrode modulation voltage VCOMIN. That is, when a predetermined sense channel is selected by a touch input, the parasitic capacitance Cb is offset by generating a quantity of charge equal to the parasitic capacitance Cb. The common electrode modulation voltage VCOMIN generated by a common electrode voltage driver 710 is applied to the parasitic capacitance compensator 730 via the touch panel 71. The parasitic capacitance compensator 730 generates a capacitance that offsets the parasitic capacitance Cb, and applies the generated capacitance to the charge amplifier 750 in parallel with the parasitic capacitor Cb. A touch input signal compensated by the charge amplifier 750 may then be output as a display image signal via a filter 760, an analog-digital converter 770, and a digital filter 780.

FIG. 7B is a circuit diagram of a touch controller 75 comprising the parasitic capacitance compensator 730 and the charge amplifier 750 in a touch display device, according to another embodiment of the inventive concept.

The parasitic capacitance Cb may be directly sensed in a common electrode layer in FIG. 7A, and thus source channel noise can be compensated, whereas the parasitic capacitance Cb is sensed in an IC common electrode pad, and thus the parasitic resistor Rₛ₁ greatly affects noise compensation.

The common electrode voltage driver 710 outputs a common electrode modulation voltage VCOM and inputs the common electrode modulation voltage VCOM into the parasitic capacitance compensator 730 as the common electrode modulation voltage VCOMIN via the parasitic resistor Rₛ₃. The common electrode modulation voltage VCOMIN is output via the parasitic resistor Rₛ₃, and is differentiated from the common electrode modulation voltage VCOM.

FIG. 7C is a circuit diagram further illustrating a method of compensating for a parasitic capacitor using the touch controller 70 of FIG. 7A, according to an embodiment of the inventive concept.

Referring to FIG. 7C, the touch controller 70 comprises the parasitic capacitance compensator 730, the charge amplifier 750, and the like as previously described. Further, the method of compensating for the parasitic capacitor according to an embodiment of the inventive concept applies the common electrode modulation voltage VCOMIN to the parasitic capacitance compensator 730 and generates a negative capacitance Cq for compensating for the parasitic capacitance Cb.

The parasitic capacitance compensator 730 includes a differential op amp, which has a non-inversion input terminal into which the common electrode modulation voltage VCOMIN and an excitation pulse VIN are input in parallel. An excitation pulse buffer 740 buffers the excitation pulse VIN and applies the excitation pulse VIN to an input terminal of the charge amplifier 750. A source driver 720 applies a source channel voltage in which the parasitic capacitance Cs of several tens nF is accumulated between a source channel and a common electrode panel. Resistors R_{X}, R_{Y}, and R_{B} connected to the non-inversion input terminal of the differential op amp may implement the same functions although the resistors R_{X}, R_{Y}, and R_{B} are replaced with capacitors C1, C2, and C3.

FIG. 7D is a circuit diagram for implementing the method of FIG. 7C, according to an embodiment of the inventive concept.

The parasitic capacitance compensator 730, which is an inversion amplifier, sums the common electrode modulation voltage VCOMIN and the excitation pulse VIN using the resistors R_{X}, R_{Y}, and R_{B} and inputs the summed value of the common electrode modulation voltage VCOMIN and the excitation pulse VIN into the non-inversion input terminal thereof. Thus, to sense a touch, the input signal Cx that is applied to the charge amplifier 750 must be input into the non-inversion input terminal of the parasitic capacitance compensator 730. In the same manner as shown in FIG. 3, the resistors R_{X}, R_{Y}, and R_{B} connected to the non-inversion input terminal of the differential op amp may implement the same functions although the resistors R_{X}, R_{Y}, and R_{B} are replaced with the capacitors C1, C2, and C3.

Consideration into the above-mentioned parasitic resistors is omitted. The common electrode modulation voltage VCOMIN is replaced with a Vc voltage source 799. The total quantity of charge formed in the parasitic capacitance Cb is proportional to a difference between the excitation pulse VIN and a common electrode voltage Vc as shown in Equation 3 below.

ΔQ_{b}=C_{b}(−V_{IN}−V_{C}) (3)

The total quantity of charge formed in the negative capacitance Cq for compensating for parasitic capacitor charges may be expressed using Equation 4 below.

$$Δ {Q}_{q} = Cq ( - {V}_{IN} - ( - \frac{{R}_{B}}{{R}_{X}} {V}_{C} - \frac{{R}_{B}}{{R}_{Y}} {V}_{IN} ) ) \qquad ( 4 )$$

If it is assumed that Cq=2Cb, Equation 5 may be expressed below.

$$If \frac{{R}_{B}}{{R}_{X}} = \frac{1}{2} and \frac{{R}_{B}}{{R}_{Y}} = \frac{3}{2} . \\ Δ {Q}_{b} = Δ {Q}_{q} \qquad ( 5 )$$

To compensate for the parasitic capacitance Cb satisfying Equation 5, a value of the negative capacitance Cq must be set to be two times greater than that of the parasitic capacitance Cb. This is because an inner amp output of the parasitic capacitor compensator 730 may exceed a power voltage.

For reference, a touch sense operates at an analog power of 5V. A variation of the common electrode modulation voltage VCOMIN is approximately 5V. The resistors R_{X}, R_{Y}, and R_{B} determine whether or not the total quantity of charge for the negative capacitance Cq and the parasitic capacitance Cb are the same. In accordance with FIG. 7D and the Equations 3 through 5, the negative capacitance Cq can remove the effect of the parasitic capacitance Cb. In more detail, only a variation of the input signal Cx formed by a touch input is used for touch sense processing via the charge amplifier 750. However, since two paths A and B may have different phases as shown in FIG. 7D, noise cannot be completely removed. In addition to the compensation circuit described above, noise may be further reduced using a frequency of the excitation pulse VIN having a bandwidth different than that of a common electrode modulation frequency and using the analog filter 760 behind the charge amplifier 750. Further, a closed loop bandwidth of a parasitic capacitance compensation circuit may be reduced according to a resistance ratio, and thus a design in consideration of such reduction is needed.

A method and device compensating a parasitic capacitance by receiving a common electrode voltage are described above. A touch panel provided with a touch controller for compensating the parasitic capacitance may be an ON-cell type touch panel in which the touch panel and a display panel are unified within a common body. When the touch panel is an overlay type touch panel, the touch controller for compensating the parasitic capacitance according to an embodiment of the inventive concept may be applied. Even when a protection layer conventionally provided to prevent noise is removed, a circuit for compensating the parasitic capacitance according to an embodiment of the inventive concept may advantageously reduce the number of panel production processes and associated fabrication costs for the display device.

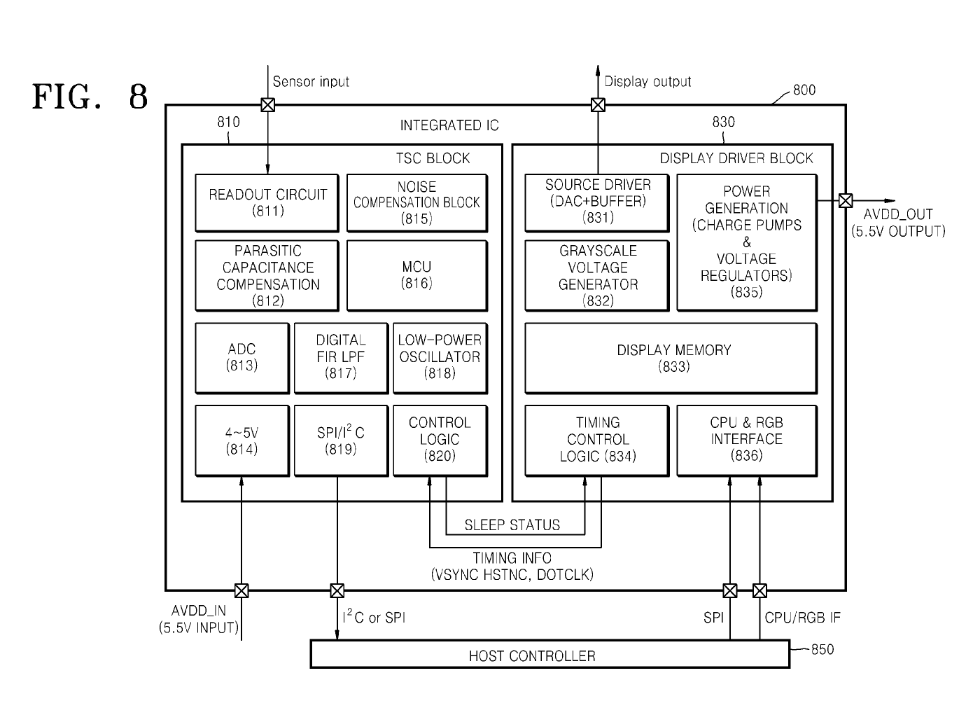

FIG. 8 is a block diagram of an integrated circuit (IC) 800 in which a touch controller and a display driver circuit are integrated in one chip, according to an embodiment of the inventive concept.

Referring to FIG. 8, the IC 800 includes a touch controller unit 810 that operates as a touch controller and performs display noise compensation, and a display driver unit 830 that operates as a display driver circuit. By integrating the touch controller unit 810 and the display driver unit 830 in one semiconductor chip, fabrication costs may be reduced.

The touch controller unit 810 may include various elements for performing operations of a touch screen. For example, the touch controller 810 may include a readout circuit 811 for generating touch data, a parasitic capacitance compensation unit 812 for reducing parasitic capacitance components of a sensing unit, an analog to digital converter (ADC) 813 for converting analog data into a digital signal, a power supply voltage generation unit 814 for generating a power supply voltage, a noise compensation block 815 for compensating for display noise, a micro control unit (MCU) 816, a digital finite impulse response (FIR) filter 817, an oscillator 818 for generating a low power oscillation signal, an interface unit 819 for transmitting and receiving signals to and from a host controller 850, a control logic unit 820, and a memory (not shown). Also, the display driver unit 830 may include a source driver 831 for generating gray scale data for display operations, a gray scale voltage generator 832, and a memory 833 for storing display data. The display driver unit 830 may include a timing control logic unit 834 and a power generation unit 835 for generating at least one power supply voltage, if necessary. Also, the display driver unit 830 may include a CPU for controlling the overall operation of the display driver unit 830 and an interface unit 836 for interfacing with the host controller 850.

The display driver unit 830 may receive at least one piece of information from the touch controller unit 810. For example, the display driver unit 830 may receive a status signal, e.g., a sleep status signal, from the touch controller unit 810, as illustrated in FIG. 8.

Also, as illustrated in FIG. 8, each of the touch controller unit 810 and the display driver unit 830 includes a circuit block for generating power, a memory for storing predetermined data, and a control unit for controlling the function of each block. As such, when the touch controller unit 810 and the display driver unit 830 are integrated in one semiconductor chip, the memory, the power generation unit 835, and the control unit may be commonly used in the touch controller unit 810 and the display driver unit 830.

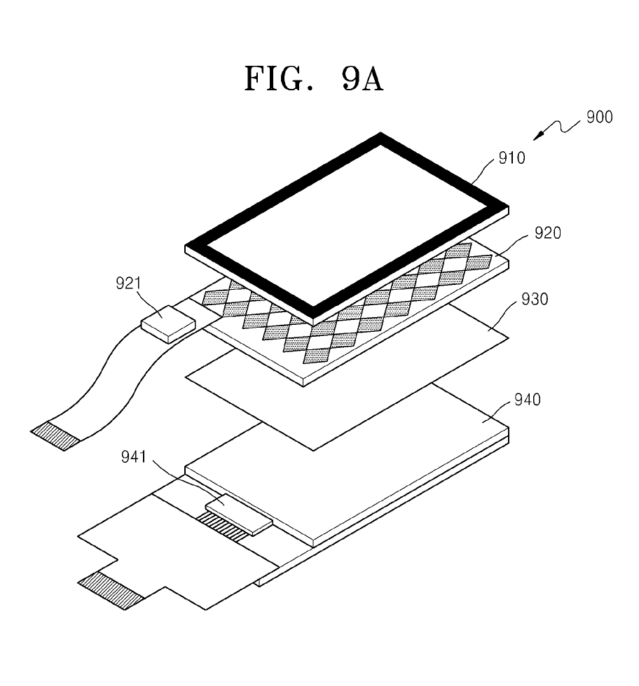

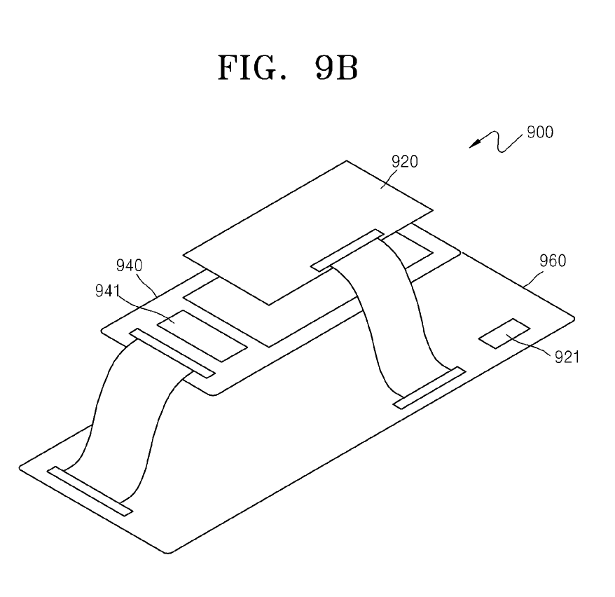

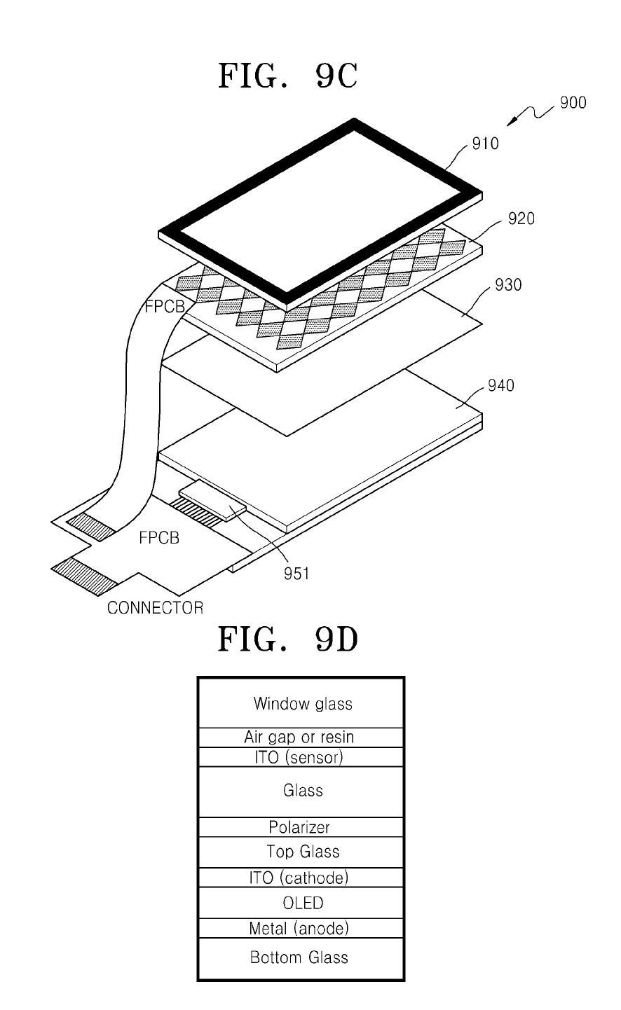

FIGS. 9A through 9D illustrate certain structures of a printed circuit board (PCB) of a display device 900 on which a touch panel 920 is disposed, according to corresponding embodiments of the inventive concept. In FIGS. 9A through 9D, a display device having a structure in which the touch panel 920 and the display panel 940 are separated from each other, is illustrated.

Referring to FIG. 9A, the display device 900 may include a window glass 910, the touch panel 920, and the display panel 940. Also, a polarizer 930 may be further disposed between the touch panel 920 and the display panel 940 so as to have optical characteristics.

The window glass 910 is manufactured of material such as acryl, tempered glass, or the like, and protects a module from scratches caused by an external shock or a repetitive touch. The touch panel 920 is formed by patterning a transparent electrode, such as an indium tin oxide (ITO), on a glass substrate or a polyethylene terephthalate (PET) film. A touch screen controller 921 may be mounted on a flexible printed circuit board (FPCB) in the form of a chip on board (COB), senses a variation in capacitances from each electrode, extracts touch coordinates, and provides the touch coordinates to a host controller. The display panel 940 is generally formed by bonding two pieces of glass that constitute a top glass and a bottom glass of the display panel 940. Also, a display driver circuit 941 is attached to a display panel for a cell phone in the form of chip on glass (COG).

FIG. 9B illustrates an example of a structure of another PCB of the display device 900 of FIG. 9A. Referring to FIG. 9B, the touch screen controller 921 may be disposed on a main board 960, and voltage signals from a sensing unit may be transmitted and received between the touch panel 920 and the touch screen controller 921 via a FPCB. On the other hand, the display driver circuit 941 may be attached in the form of the COG, as illustrated in FIG. 9A. The display driver circuit 941 may be connected to the main board 960 via the FPCB. In detail, the touch screen controller 921 and the display driver unit 941 may transmit and receive various information and signals to and from the main board 960.

FIG. 9C illustrates a structure of the display device 900 when the touch screen controller unit 921 and the display driver unit 941 are integrated in one semiconductor chip 951. Referring to FIG. 9C, the display device 900 may include a window glass 910, a touch panel 920, a polarizer 931, and a display panel 940. In particular, the semiconductor chip 951 may be attached to the display panel 940 in the form of the COG. The touch panel 920 and the semiconductor chip 951 may be electrically connected to each other via a FPCB.

FIG. 9D illustrates one possible structure for a panel of the display device 900 illustrated in FIGS. 9A, 9B, and 9C. FIG. 9D illustrates an OLED as a display device. Referring to FIG. 9D, a sensing unit may be formed by patterning a transparent electrode ITO (sensor) and may be formed on an additional glass separated from a display panel. The glass substrate on which the sensing unit is formed may be separated from a window glass due to a predetermined air gap or resin and may also be separated from the top glass and the bottom glass that constitute the display panel based on the polarizer 931.

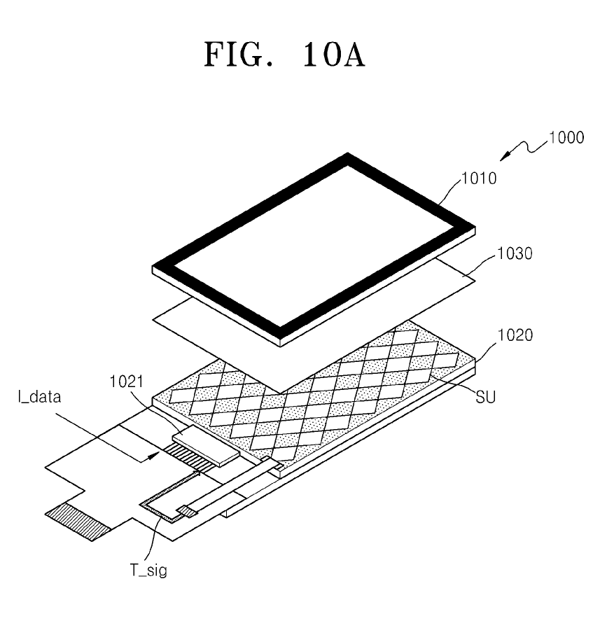

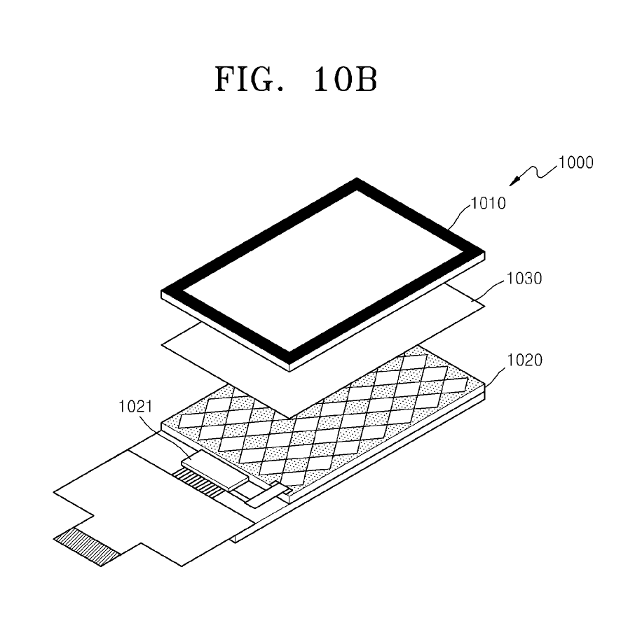

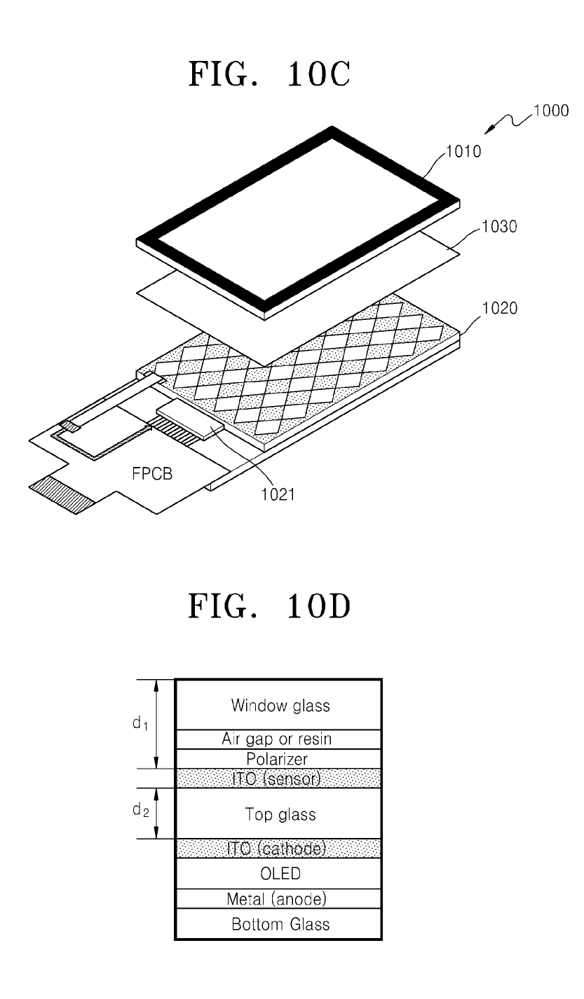

FIGS. 10A through 10D illustrate certain structures of a PCB when a touch panel and a display panel are unified within a common body. Referring to FIG. 10A, a display device 1000 may include a window glass 1010, a display panel 1020, and a polarizer 1030. In particular, when the touch panel is realized, the touch panel is not formed on an additional glass substrate but may be formed by patterning transparent electrodes on a top glass of the display panel 1020. FIG. 10A illustrates an example in which a plurality of sensing units SU are disposed on the top glass of the display panel 1020. Also, when the structure of the PCB is constituted in this manner, one semiconductor chip 1021 in which a touch controller unit and a display driver unit are integrated may be used.

When the touch controller unit and the display driver unit are integrated in one semiconductor chip 1021, a voltage signal T_sig from the sensing unit SU and image data I_data from an external host are provided to the semiconductor chip 1021. Also, the semiconductor chip 1021 processes the image data I_data, generates gray scale data (not shown) for driving the display device 1000, and provides the gray scale data to the display panel 1020. To this end, the semiconductor chip 1021 may include a pad related to touch data T_data and a pad related to the image data I_data and the gray scale data (not shown). The semiconductor chip 1021 receives the voltage signal T_sig from the sensing unit SU via a conductive line connected to one side of the touch panel.

When the pads are disposed on the semiconductor chip 1021, the pad for receiving the voltage signal T_sig may be disposed adjacent to the conductive line for transferring the voltage signal T_sig (such that noise in the data can be reduced). Although not shown in FIG. 10A, when the conductive line for providing the gray scale data to the display panel 1020 is on an opposite side to the side of a conductive line for transferring the voltage signal T_sig of the touch data T_data, the pad for providing the gray scale data may be disposed on an opposite side to the side of the pad for receiving the voltage signal T_sig.

FIG. 10B has a nearly similar structure to that of the display device 1000 of FIG. 10A and illustrates an example in which a voltage signal from a sensing unit is not provided to the semiconductor chip 1021 via the FPCB but is directly provided to the semiconductor chip 1021 via a conductive line. Also, a display device 1000 of FIG. 10C has a nearly similar structure to that of the display device 1000 of FIG. 10A, or a path of the display device 1000 of FIG. 10C on which the voltage signal from the sensing unit is transferred to the semiconductor chip 1021 is different from that of the display device 1000 of FIG. 10A. In this case, among the pads disposed on the semiconductor chip 1021, the pad for receiving the voltage signal from the sensing unit is disposed relatively close to the conductive line.

FIG. 10D illustrates a structure of a panel of the display devices 1000 illustrated in FIGS. 10A, 10B, and 10C. In the display device 1000 of FIGS. 10A, 10B, and 10C, the touch panel and the display panel can be efficiently unified with each other as one body. FIG. 10D illustrates an OLED as a display device. A transparent electrode ITO (sensor) is not formed on an additional glass substrate or a PET film but may be directly formed on the top glass of the display panel, as illustrated in FIG. 10D. In this case, when the touch display panel is realized, production costs and the thickness of a module can be reduced. However, as the distance between the transparent electrode ITO (sensor) and the top glass of the display panel decreases, vertical parasitic capacitance components of the sensing unit increase. However, by reducing an effect caused by the entire parasitic capacitance components including the vertical parasitic capacitance components of the sensing unit by using an appropriate method, the touch panel and the display panel can be efficiently unified with each other as one body.

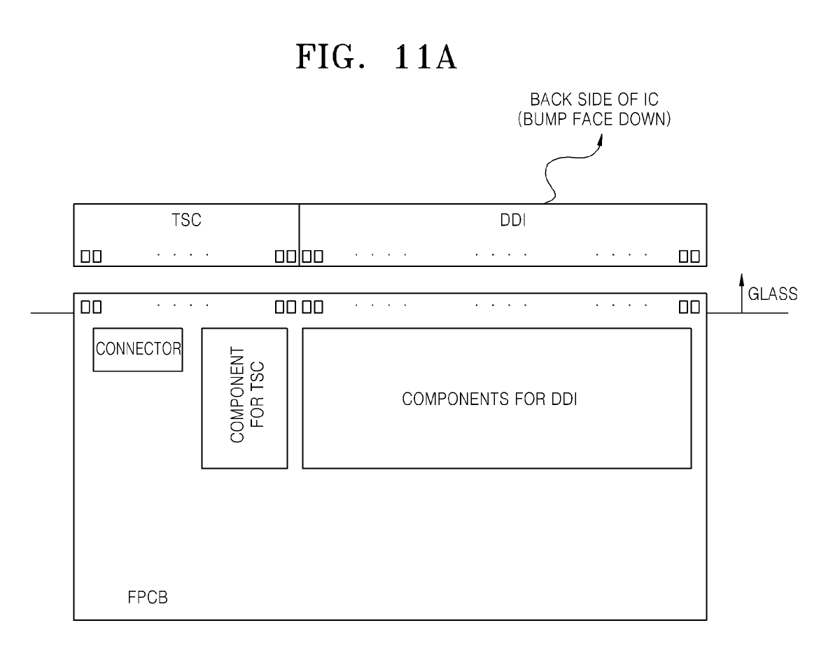

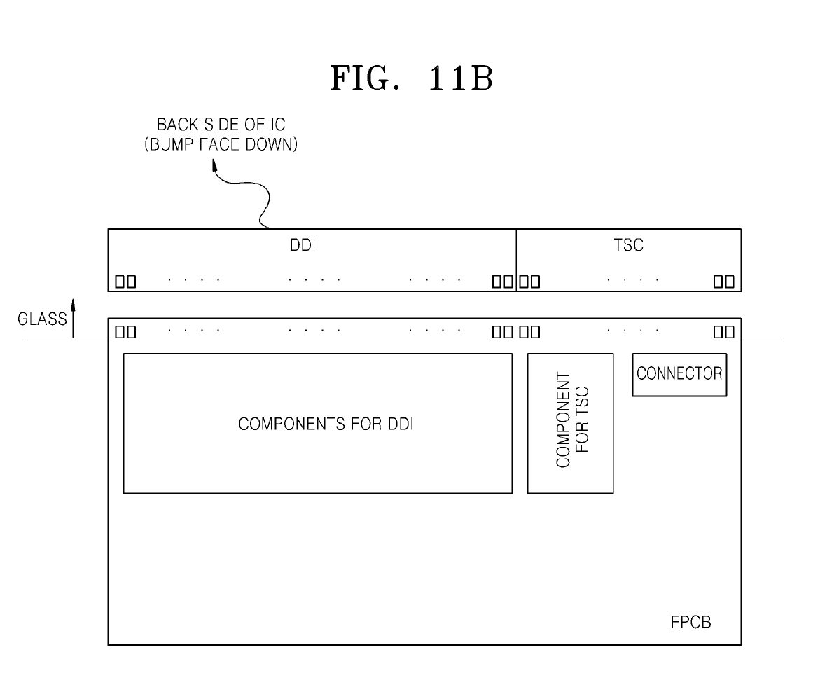

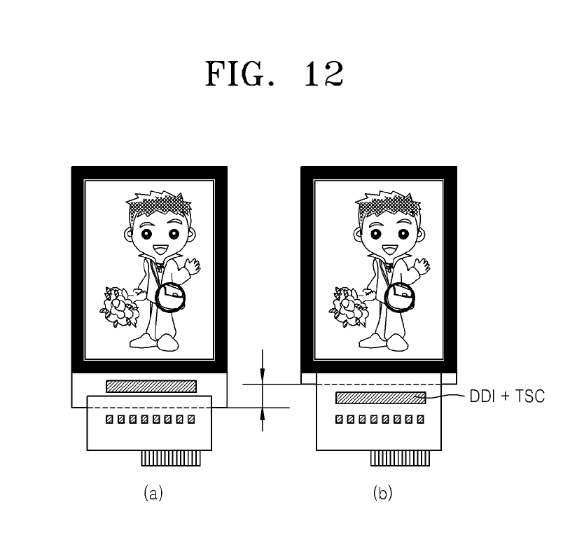

FIGS. 11A and 11B illustrate possible layout structures for a semiconductor chip in which the touch controller unit and the display driver circuit unit are integrated, and a corresponding structure of a FPCB. The semiconductor chip includes pads for transmitting and receiving signals related to the touch controller unit, and pads for transmitting and receiving signals related to the display driver circuit unit. The pads may be electrically connected to an external touch panel, a display panel, a host controller, or the like via a connection terminal of the FPCB. When the semiconductor chip is realized, a region in which the touch controller unit is disposed and a region in which the display driver circuit unit is disposed may be separated from each other. When the connection terminal is disposed on the FPCB, a connection terminal connected to the signals related to the touch controller unit and a connection terminal connected to the signals related to the display driver circuit unit may be separated from each other, so as to correspond to the pads of the semiconductor chip.

FIG. 12, inclusive of FIGS. 12(a) and 12(b), illustrates a display device including a semiconductor chip in which a touch controller unit and a display driver circuit are installed, according to an embodiment of the inventive concept. FIG. 12(a) illustrates an example in which the semiconductor chip is disposed on glass of a display panel in the form of a COG, and FIG. 12(b) illustrates an example in which the semiconductor chip is disposed on a film of the display panel in the form of a chip on film (COF).

When the touch controller unit and the display driver circuit are disposed on separate chips, the touch controller unit may be usually disposed in the form of the COF, and the display driver circuit may be usually disposed in the form of the COG. However, the semiconductor chip in which the touch controller unit and the display driver circuit are installed, as illustrated in FIG. 12, may be disposed in any form of the COG and COF.

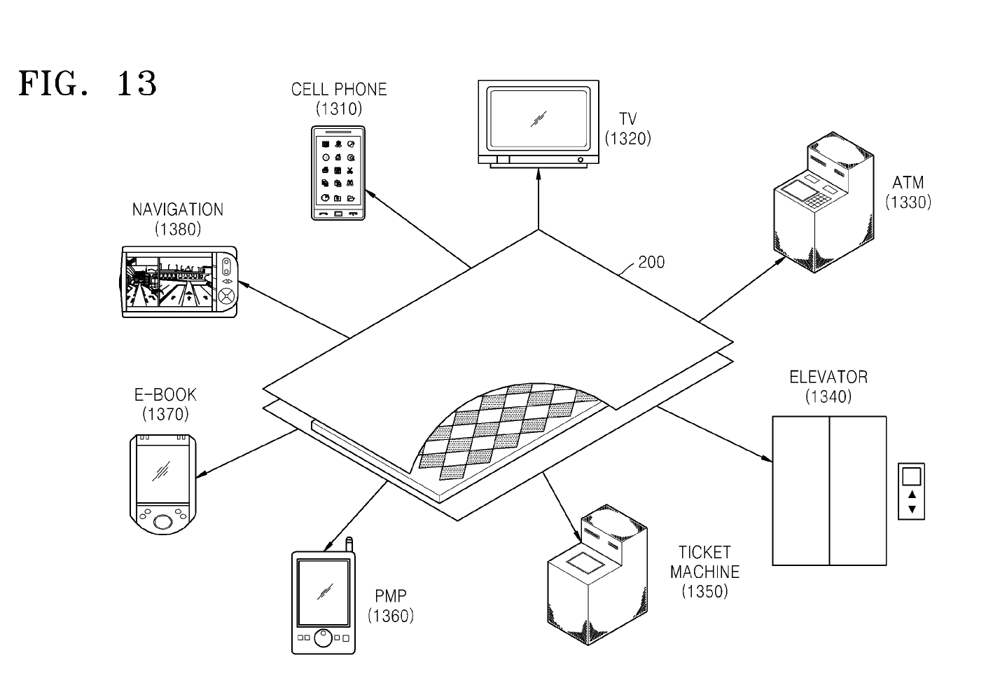

FIG. 13 illustrates examples for various product applications for a touch system according to embodiments of the inventive concept. Touch screen type products are widely used in various fields of industry and are rapidly replacing button type devices due to their superior spatial characteristics. The most explosive demand is in the field of cell phones. In particular, in cell phones, convenience and the size of a terminal are very significant and thus, touch phones that do not include additional keys or minimize the number of keys have recently come into the spotlight. Thus, a touch system 1300 according to the current embodiment of the inventive concept can be employed in a cell phone 1310 and can also be widely used in a television (TV) 1320 including a touch screen, an asynchronous transfer mode (ATM) device 1330 that automatically serves cash withdrawal and remittance of a bank, an elevator 1340, a ticket machine 1350 used in a subway, a portable multimedia player (PMP) 1360, an e-book 1370, a navigation device 1380, and the like. Besides, the touch display device replaces a general button type interface in all fields that require a user interface.

The inventive concept may be implemented by a method, an apparatus, a system or the like. When the inventive concept is implemented by software, elements of the inventive concept are code segments for executing an essential work. Programs or code segments may be stored in a processor readable medium

While the inventive concept has been particularly shown and described with reference to exemplary embodiments thereof, it will be understood that various changes in form and details may be made therein without departing from the scope of the following claims.

What is claimed is:

1. A touch controller comprising:
a parasitic capacitance compensation unit that receives a common electrode voltage to generate a quantity of charge capable of compensating for a quantity of charge associated with a parasitic capacitance between a sensing channel and a common electrode in a touch panel capable of capacitive sensing of a touch input.

2. The touch panel of claim 1, wherein the parasitic capacitance compensation unit receives an excitation pulse in parallel with the common electrode voltage.

3. The touch panel of claim 2, wherein the parasitic capacitance compensation unit comprises a differential op amplifier that receives the common electrode voltage and the excitation pulse via an inversion input terminal.

4. The touch panel of claim 3, wherein the excitation pulse and the common electrode voltage are summed and applied to the differential op amplifier.

5. The touch panel of claim 4, wherein the quantity of charge associated with the parasitic capacitance is proportional to a voltage difference between the excitation pulse and the common electrode voltage.

6. The touch panel of claim 3, further comprising:
a negative capacitor connected to an output of the differential op amplifier and compensating for the parasitic capacitance.

7. The touch panel of claim 6, wherein a capacitance of the negative capacitor ranges from between about 1.7 times the parasitic capacitance to about 2.3 times the parasitic capacitance.

8. The touch panel of claim 1, further comprising:
a signal conversion unit that receives a touch signal, the touch signal being generated by sensing a variation in a sensing unit disposed in the sensing channel in the touch panel;
a filtering unit that filters the touch signal; and
an analog-digital conversion unit that converts the touch signal from an analog signal into a corresponding digital signal.

9. A touch display device compensating for parasitic capacitance, the touch display device comprising:
a touch panel comprising a plurality of sensing channels that perform a touch screen operation of sensing a variation in a sensing unit disposed in the plurality of sensing channels, and outputting a touch signal of the sensing unit, the touch signal being generated during the touch screen operation; and
a touch controller comprising a signal conversion unit that receives the variation signal, converts the variation signal into a voltage, and outputs the voltage,
wherein the touch controller comprises:
a parasitic capacitance compensation unit that receives a common electrode voltage to generate a quantity of charge capable of compensating for a quantity of charge associated with a parasitic capacitance between a sensing channel and a common electrode in the touch panel.

10. The touch display device of claim 9, wherein the parasitic capacitance compensation unit that receives an excitation pulse in parallel with the common electrode voltage.

11. The touch display device of claim 10, wherein the parasitic capacitance compensation unit comprises a differential op amplifier that receives the common electrode voltage and the excitation pulse via an inversion input terminal.

12. The touch display device of claim 11, wherein the excitation pulse and the common electrode voltage are summed and applied to the differential op amplifier.

13. The touch display device of claim 12, wherein the quantity of charge associated with the parasitic capacitance is proportional to a voltage difference between the excitation pulse and the common electrode voltage.

14. The touch display device of claim 11, further comprising:
a negative capacitor connected to an output of the differential op amplifier and compensating for the parasitic capacitance.

15. The touch display device of claim 14, wherein a capacitance of the negative capacitor ranges from about 1.7 times the parasitic capacitance to about 4 times the parasitic capacitance.

16. The touch display device of claim 9, wherein the touch controller further comprises:
a filtering unit that filters the touch signal; and
an analog-digital conversion unit that converts the touch signal from an analog signal into a corresponding digital signal.

17. The touch display device of claim 9, wherein the touch panel comprises an ON-cell type touch panel unified with the display panel in a common body.

18. The touch display device of claim 9, wherein the touch panel comprises an overlay touch panel.

19. The touch display device of claim 9, wherein the common electrode of the touch display device does not include a common electrode protection layer.

20. A method compensating for parasitic capacitance in a touch system, the method comprising:
sensing variation in capacitance for a plurality of sensing units disposed in a plurality of sensing channels in response to a touch input, and outputting a touch signal corresponding to the variation;
receiving, amplifying, and outputting the touch signal, wherein the receiving, amplifying, and outputting of the touch signal is performed by a touch controller; and
receiving a common electrode voltage to generate a quantity of charge capable of compensating for a quantity of charge associated with a parasitic capacitance between the plurality of sensing channels and a common electrode, wherein the receiving of the common electrode voltage is performed by a parasitic capacitance compensation unit of the touch controller.

21. The method of claim 20, wherein the parasitic capacitor compensation unit receives an excitation pulse in parallel with the common electrode voltage.

22. The method of claim 21, wherein the parasitic capacitor compensation unit comprises a differential op amplifier that receives the common electrode voltage and the excitation pulse via an inversion input terminal.

23. The method of claim 22, wherein the excitation pulse and the common electrode voltage are summed and applied to the differential op amplifier.

24. The method of claim 23, wherein the quantity of charge associated with the parasitic capacitance is proportional to a voltage difference between the excitation pulse and the common electrode voltage.

25. The method of claim 22, wherein the touch system comprises: a negative capacitor connected to an output of the differential op amplifier and compensating for the parasitic capacitance.

26. The method of claim 25, wherein capacitance of the negative capacitor ranges from between about 1.7 times the parasitic capacitance to about 2.3 times the parasitic capacitance.

27. The method of claim 20, further comprising:
filtering the touch signal following amplifying of the touch signal; and
converting the touch signal following filtering of the touch signal from an analog form to a corresponding digital form.

28. The method of claim 20, wherein the touch panel of the touch system comprises an ON-cell type touch panel unified with a display panel in a common body.

29. The method of claim 20, wherein the touch panel of the touch system comprises an overlay touch panel.
